(19) United States
(12) Patent Application Publication
(10) Pub. No.: US 2024/0160949 A1
(43) Pub. Date: May 16, 2024

(54) GENERATING META-SUBNETS FOR EFFICIENT MODEL GENERALIZATION IN A MULTI-DISTRIBUTION SCENARIO

(71) Applicant: Tata Consultancy Services Limited, Mumbai (IN)

(72) Inventors: Shruti Kunal KUNDE, Thane West (IN); Rekha SINGHAL, Thane West (IN); Varad Anant PIMPALKHUTE, Thane West (IN)

(73) Assignee: Tata Consultancy Services Limited, Mumbai (IN)

(21) Appl. No.: 18/454,329

(22) Filed: Aug. 23, 2023

(30) Foreign Application Priority Data
Oct. 19, 2022 (IN) 202221059849

(51) Int. Cl. G06N 3/0985

(52) U.S. Cl. CPC G06N 3/0985

(57) ABSTRACT

Technical limitation of conventional Gradient-Based Meta Learners is their inability to adapt to scenarios where input tasks are sampled from multiple distributions. Training multiple models, with one model per distribution adds to the training time owing to increased compute. A method and system for generating meta-subnets for efficient model generalization in a multi-distribution scenario using Binary Mask Perceptron (BMP) technique or a Multi-modal Meta Supermasks (MMSUP) technique is provided. The BMP utilizes an adaptor which determines a binary mask, thus training only those layers which are relevant for given input distribution, leading to improved training accuracy in a cross-domain scenario. The MMSUP, further determines relevant subnets for each input distribution, thus, generalizing well as compared to standard MAML. The BMP and MMSUP, beat Multi-MAML in terms of training time as they train a single model on multiple distributions as opposed to Multi-MAML which trains multiple models.

### PRIORITY CLAIM

This U.S. patent application claims priority under 35 U.S.C. § 119 to: India Application No. 202221059849, filed on Oct. 19, 2022. The entire contents of the aforementioned application are incorporated herein by reference.

### TECHNICAL FIELD

The embodiments herein generally relate to the field of meta learning and, more particularly, to a method and system for generating meta-subnets for efficient model generalization in a multi-distribution scenario.

### BACKGROUND

Human beings quickly learn to identify objects in their surroundings by observing just a few samples and utilizing previous knowledge. Meta-learning, or learning-to-learn, aims to emulate the human brain by training a model on few tasks from a distribution (also known as few-shot learning) and generalizing on unseen tasks from the same distribution. Commonly used Gradient-Based Meta-Learning (GBML) algorithms such as Model-Agnostic Meta-Learners (MAML) aim to learn an optimal model-prior, such that the model converges rapidly with few gradient updates when exposed to unseen tasks sampled from the same distribution. The basic premise behind GBML is to learn the underlying structure of the input task. Model generalizes well if the structure of the unseen tasks is similar to that of the training tasks.

Most state-of-the-art GBML algorithms in the literature assume that tasks are sampled from either the same or similar distributions. As similarity among the distributions decreases, there is an increase in negative knowledge transfer, resulting in deterioration of model accuracy. It becomes imperative to use multiple model initializations for tasks sampled from different distributions. For example, a human-being may apply the knowledge gained to drive a four-wheeler (car) of a particular model, to different types of four-wheeled vehicles. The same knowledge may not be beneficial for flying an aircraft or riding a bike. The solution can be using a task specific multiple model approach. However, training on multiple model initializations (e.g., Multi-MAML) results in a linear increase in training time, albeit resulting in a better generalization as compared to training on a single model initialization. Thus, Multi-MAML is not a practical approach even though the prediction accuracy or model performance is good. Consequently, a trade-off is observed between the computation cost and model performance when using conventional methods of GBML such as MAML or multi-MAML.

### SUMMARY

Embodiments of the present disclosure present technological improvements as solutions to one or more of the above-mentioned technical problems recognized by the inventors in conventional systems.

For example, in one embodiment, a method for model generalization during meta learning is provided. The method includes sampling a dataset having task distribution across a plurality of classes to generate a batch of tasks comprising tasks across the plurality of classes. Further, the method incudes training a meta learner base model (f_{θ}), with each task from among the batch of tasks for task generalization to obtain a trained meta learner model having single model initialization parameters (θ) providing model generalization for the batch of tasks. The training is based on one of: (i) A Binary Mask Perceptron (BMP) technique that utilizes an adaptor network to generate task specific binary masks, wherein the task specific binary masks are applied on the meta learner base model (f_{θ}) to dynamically freeze layers depending on task characteristics, and task specific learning rates to determine task specific model initialization parameters capturing distribution specific parameters in inner loop of the training, The task specific model initialization parameters are generalized for the subset of tasks in the outer loop of the training to obtain the single model initialization parameters (θ). (ii) A Multi-modal Meta Supermasks (MMSUP) technique comprising updating generated task specific subnetworks during inner loop of training, and updating the single model initialization parameters (θ) during outer loop of the training based on the loss calculated for the task specific and task agnostic parameters of the generated task specific subnetworks. Furthermore, the method utilizes the trained meta learner model for inferencing with tasks from multiple distributions received for prediction for a user application.

In another aspect, a system for model generalization during meta earning in a multi-distribution scenario is provided. The system comprises a memory storing instructions; one or more Input/Output (I/O) interfaces; and one or more hardware processors coupled to the memory via the one or more I/O interfaces, wherein the one or more hardware processors are configured by the instructions to sample a dataset having task distribution across a plurality of classes to generate a batch of tasks comprising tasks across the plurality of classes. Further, the one or more hardware processors are configured to train a meta learner base model (f_{θ}), with each task from among the batch of tasks for task generalization to obtain a trained meta learner model having single model initialization parameters (θ) providing model generalization for the batch of tasks. The training is based on one of: (i) A Binary Mask Perceptron (BMP) technique that utilizes an adaptor network to generate task specific binary masks, wherein the task specific binary masks are applied on the meta learner base model (f_{θ}) to dynamically freeze layers depending on task characteristics, and task specific learning rates to determine task specific model initialization parameters capturing distribution specific parameters in inner loop of the training, The task specific model initialization parameters are generalized for the subset of tasks in the outer loop of the training to obtain the single model initialization parameters (θ). (ii) A Multi-modal Meta Supermasks (MMSUP) technique comprising updating generated task specific subnetworks during inner loop of training, and updating the single model initialization parameters (θ) during outer loop of the training based on the loss calculated for the task specific and task agnostic parameters of the generated task specific subnetworks. Furthermore, the one or more hardware processors are configured to utilize the trained meta learner model for inferencing with tasks from multiple distributions received for prediction for a user application.

In yet another aspect, there are provided one or more non-transitory machine-readable information storage mediums comprising one or more instructions, which when executed by one or more hardware processors causes a method for model generalization during meta earning in a multi-distribution scenario

The method includes sampling a dataset having task distribution across a plurality of classes to generate a batch of tasks comprising tasks across the plurality of classes. Further, the method incudes training a meta learner base model (f_{θ}), with each task from among the batch of tasks for task generalization to obtain a trained meta learner model having single model initialization parameters (θ) providing model generalization for the batch of tasks. The training is based on one of: (i) A Binary Mask Perceptron (BMP) technique that utilizes an adaptor network to generate task specific binary masks, wherein the task specific binary masks are applied on the meta learner base model (f_{θ}) to dynamically freeze layers depending on task characteristics, and task specific learning rates to determine task specific model initialization parameters capturing distribution specific parameters in inner loop of the training, The task specific model initialization parameters are generalized for the subset of tasks in the outer loop of the training to obtain the single model initialization parameters (θ). (ii) A Multi-modal Meta Supermasks (MMSUP) technique comprising updating generated task specific subnetworks during inner loop of training, and updating the single model initialization parameters (θ) during outer loop of the training based on the loss calculated for the task specific and task agnostic parameters of the generated task specific subnetworks. Furthermore, the method utilizes the trained meta learner model for inferencing with tasks from multiple distributions received for prediction for a user application.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 is a functional block diagram of a system for generating meta-subnets for efficient model generalization in a multi-distribution scenario, in accordance with some embodiments of the present disclosure.

FIG. 2 is a flow diagram illustrating a method for generating meta-subnets for efficient model generalization in a multi-distribution scenario, using the system of FIG. 1, in accordance with some embodiments of the present disclosure.

FIG. 3 depicts training of a meta learner base model of the system of FIG. 1 for task generalization to obtain a trained meta learner model using a Binary Mask Perceptron (BMP) technique, in accordance with some embodiments of the present disclosure.

FIG. 4 depicts training of the meta learner base model of the system of FIG. 1 for task generalization to obtain a trained meta learner model using a Multi-modal Meta Supermasks (MMSUP) technique, in accordance with some embodiments of the present disclosure.

It should be appreciated by those skilled in the art that any block diagrams herein represent conceptual views of illustrative systems and devices embodying the principles of the present subject matter. Similarly, it will be appreciated that any flow charts, flow diagrams, and the like represent various processes which may be substantially represented in computer readable medium and so executed by a computer or processor, whether or not such computer or processor is explicitly shown.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

The idea of learning-to-learn with few shots has been prevalent for some time now. Most model agnostic meta-learners aim to learn a model initialization for a certain task distribution leading to fast adaption using gradient descent. The results reported based on these meta learners are encouraging. Model-Agnostic Meta-Learners (MAML) is a Gradient-Based Meta Learners (GBML) algorithm that tries to find the optimal model initialization for an input distribution. It is model-agnostic and is widely used across various domains for few-shot learning. Certain variants of MAML are focused on improving task specific learning in the inner loop, whereas others are focused on improving task-agnostic learning in the outer loop. Some works in the art are focused on addressing challenges in MAML such as overfitting, unstable training, compute-efficient, etc.

However, the performance of such approaches is limited, especially when the taskset is sampled from multi-modal task distributions. Multi-initialization MAML and Multimodal MAML (MMAML) addresses the challenge of training multiple distributions on a single initialization. Training multiple distributions on a single initialization leads to deterioration of accuracy, resulting in a need to train multiple initializations. Multi-MAML (training [symbol] distributions on [symbol] corresponding initializations) reduces negative knowledge transfer, based on the assumption that the input task distribution is known. MMAML addresses this issue by introducing a modulation network that automates the process of identifying the mode (initialization) of the input task. However, both Multi-MAML and MMAML are computation expensive as they train on different N initializations and not a single initialization, leading to an increase in the overall training time. Furthermore, no knowledge is shared between tasks from different distributions.

Another approach used in training meta learner models is gradient sparsity. Instead of fixing the layers or parameters to be frozen during training, meta learner learns a binary mask corresponding to the parameters of the backbone. These set of parameters are masked on the weights of the backbone, akin to switching trainable and non-trainable parameters. However, meta-learning additional set of parameters leads to a computational overhead. Instead, a method and system is disclosed that utilizes a simple Multi-Layer Perceptron (MLP) having very less parameters that finds trainable layers instead of trainable parameters. Additionally, work in the literature, ‘Learning where to learn: Gradient sparsity in meta and continual learning’ by Johannes von Oswald, et.al. is inclined more towards single distributional training as opposed multi-distributional training approach disclosed herein.

Another approach used in training meta learner models is Network Pruning, which focuses on pruning weights of the underlying backbone to reduce the computational expense during training and inference in GBML algorithms. One of the literature work make use of Lottery Ticket Hypothesis2 to determine a sub-network that has a sufficiently good accuracy, thus pruning rest of the weights in the backbone. While this does result in reduced computation, it comes at the cost of deterioration in accuracy. Instead, as in the method disclosed herein, updating weights of the sub-network is performed while freezing rest of the other weights, which ensures only the relevant weights are updated while retaining the knowledge gained from previous tasks. This reduces unnecessary computation.

Thus, it is observed that technical limitation of conventional GBML is their inability to adapt to scenarios where input tasks are sampled from multiple distributions. Training multiple models, with one model per distribution adds to the training time owing to increased compute. Consequently, a trade-off is observed between the computation cost and model performance when using conventional methods of GBML such as the MAML that use single model initialization or multi-MAML that utilizes task specific multiple models for enhanced prediction accuracy of meta learner models. Embodiments disclosed herein address the trade-off, by providing an efficient strategy for multi-distributional training of GBML algorithms. A work in literature demonstrates that a meta learner model is capable of generalizing well on unseen tasks from similar distributions even if all layers in the network, except the head-layer are frozen. The efficacy of this approach decreases in a multi-distribution scenario as the layers are frozen agnostic to the structure of the input task.

The embodiments of method disclosed herein determine the specific layers to freeze, based on the structure of the input distribution. Deeper exploration within parameters of the layer, enables to train the meta learner model on task-specific parameters and share the knowledge gained across task-agnostic parameters, resulting in an improved generalization in a multi-distributional setting. Thus, a method and system for generating meta-subnets for efficient model generalization in a multi-distribution scenario using a Binary Mask Perceptron (BMP) technique or a Multi-modal Meta Supermasks (MMSUP) technique is provided. The BMP utilizes an adaptor which determines a binary mask, thus training only those layers which are relevant for given input distribution, leading to improved training accuracy in a cross-domain scenario. The MMSUP technique, further determines relevant subnets for each input distribution, thus, generalizing well as compared to standard MAML. The BMP technique and the MMSUP technique, beat Multi-MAML in terms of training time as they train a single model on multiple distributions as opposed to Multi-MAML which trains multiple models.

The method and the system, also referred to as Generating Efficient Meta-Subnets (GEMS) system, maximizes the accuracy in a multi-distributional setting, while minimizing the compute and training time. The method and system disclosed herein provides and optimal combination of accuracy (model performance) and training time during meta learner model training to obtain the single model initialization parameters using the BMP technique and the MMSUP technique such that training time is less than gold standard multi-Model-Agnostic Meta-Learners (multi-MAML) while the accuracy of the trained meta learner model is at least equal to baseline MAML.

MAML_{(Acc.)}≤GEMS_{(Acc)}≤MULTI-MAML_{(Acc.)}

MAML_{(Cmp.)}≤GEMS_{(Cmp.)}≤MULTI-MAML_{(Cmp.)}

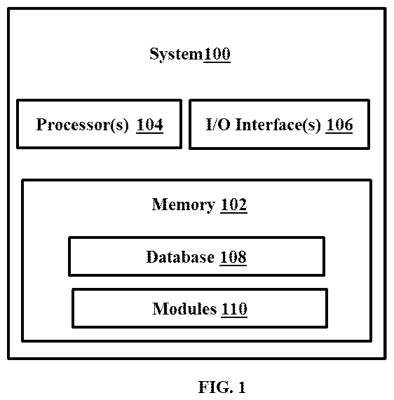

Referring now to the drawings, and more particularly to FIGS. 1 through 4, where similar reference characters denote corresponding features consistently throughout the figures, there are shown preferred embodiments and these embodiments are described in the context of the following exemplary system and/or method.

FIG. 1 is a functional block diagram of a system 100, for generating meta-subnets for efficient model generalization in a multi-distribution scenario, in accordance with some embodiments of the present disclosure.

In an embodiment, the system 100 includes a processor(s) 104, communication interface device(s), alternatively referred as input/output (I/O) interface(s) 106, and one or more data storage devices or a memory 102 operatively coupled to the processor(s) 104. The system 100 with one or more hardware processors is configured to execute functions of one or more functional blocks of the system 100.

Referring to the components of system 100, in an embodiment, the processor(s) 104, can be one or more hardware processors 104. In an embodiment, the one or more hardware processors 104 can be implemented as one or more microprocessors, microcomputers, microcontrollers, digital signal processors, central processing units, state machines, logic circuitries, and/or any devices that manipulate signals based on operational instructions. Among other capabilities, the one or more hardware processors 104 are configured to fetch and execute computer-readable instructions stored in the memory 102. In an embodiment, the system 100 can be implemented in a variety of computing systems including laptop computers, notebooks, hand-held devices such as mobile phones, workstations, mainframe computers, servers, and the like.

The I/O interface(s) 106 can include a variety of software and hardware interfaces, for example, a web interface, a graphical user interface and the like and can facilitate multiple communications within a wide variety of networks N/W and protocol types, including wired networks, for example, LAN, cable, etc., and wireless networks, such as WLAN, cellular and the like. In an embodiment, the I/O interface (s) 106 can include one or more ports for connecting to a number of external devices or to another server or devices.

The memory 102 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, the memory 102 includes a plurality of modules 110 that may include a meta learner base model and a trained meta learner model, a module for executing the BMP technique, a module for executing the MMSUP technique to obtain the trained meta learner model (not shown).

Further, the plurality of modules 110 include programs or coded instructions that supplement applications or functions performed by the system 100 for executing different steps involved in the process of single model initialization by efficiently determining meta-subnets, being performed by the system 100. The plurality of modules 110, amongst other things, can include routines, programs, objects, components, and data structures, which performs particular tasks or implement particular abstract data types. The plurality of modules 110 may also be used as, signal processor(s), node machine(s), logic circuitries, and/or any other device or component that manipulates signals based on operational instructions. Further, the plurality of modules 110 can be used by hardware, by computer-readable instructions executed by the one or more hardware processors 104, or by a combination thereof.

Further, the memory 102 may comprise information pertaining to input(s)/output(s) of each step performed by the processor(s) 104 of the system 100 and methods of the present disclosure.

Further, the memory 102 includes a database 108. The database (or repository) 108 may include a plurality of abstracted piece of code for refinement and data that is processed, received, or generated as a result of the execution of the plurality of modules in the module(s) 110. The database 108 may store task specific binary masks, task specific model initialization parameters created when the BMP technique is implemented. Similarly, the database 106 stores task specific sub networks created when the MMSUP technique is implemented.

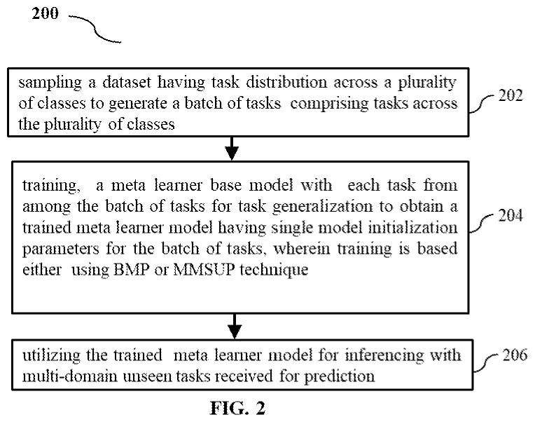

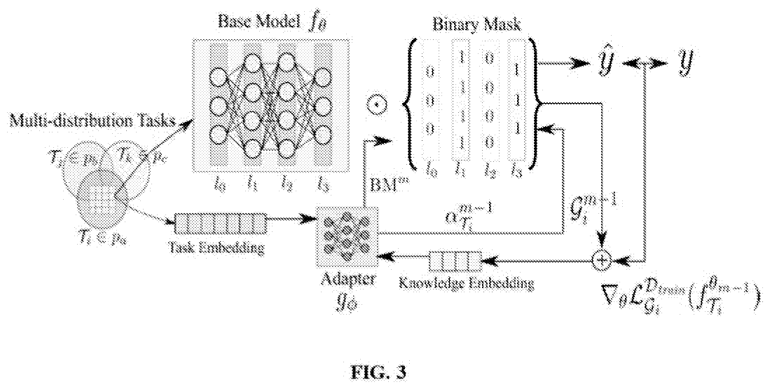

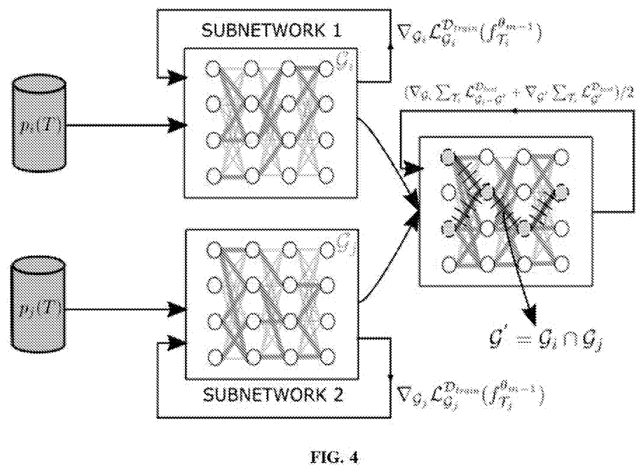

Although the data base 108 is shown internal to the system 100, it will be noted that, in alternate embodiments, the database 108 can also be implemented within external database and may be periodically updated. For example, new data may be added into the database (not shown in FIG. 1) and/or existing data may be modified and/or non-useful data may be deleted from the database. In one example, the external database includes a Lightweight Directory Access Protocol (LDAP) directory and a Relational Database Management System (RDBMS). Functions of the components of the system 100 are now explained with reference to steps in flow diagrams in FIG. 2, and FIG. 3 and FIG. 4.

FIG. 2 is a flow diagram illustrating a method 200 for single model initialization by efficiently determining meta-subnets to generalize task in multiple distribution scenario, using the system of FIG. 1, in accordance with some embodiments of the present disclosure.

In an embodiment, the system 100 comprises one or more data storage devices or the memory 102 operatively coupled to the processor(s) 104 and is configured to store instructions for execution of steps of the method 200 by the processor(s) or one or more hardware processors 104. The steps of the method 200 of the present disclosure will now be explained with reference to the components or blocks of the system 100 as depicted in FIG. 1 and the steps of flow diagram as depicted in FIG. 2. Although process steps, method steps, techniques or the like may be described in a sequential order, such processes, methods, and techniques may be configured to work in alternate orders. In other words, any sequence or order of steps that may be described does not necessarily indicate a requirement that the steps to be performed in that order. The steps of processes described herein may be performed in any order practical. Further, some steps may be performed simultaneously.

Referring to the steps of the method 200, at step 202 of the method 200, the one or more hardware processors 104 sample a dataset having task distribution across a plurality of classes to generate a batch of tasks comprising tasks across the plurality of classes. At step 204 of the method 200, the one or more hardware processors 104 train a meta learner base model (f_{θ}) with each task from among the batch of tasks for task generalization to obtain a trained meta learner model having single model initialization parameters θ for the batch of tasks. As well-known in the art the model initialization parameters refer to something which the meta learner model learns on its own, for example, model weights. The meta learner base model architecture is similar to the original MAML in the art, comprising 4 modules with 3×3 convolutions and 64 filters with a stride of 2, followed by batch normalization, a ReLU nonlinearity and 2×2 max-pooling.

Referring back to training of the meta learner base model, the training utilizes one of the two techniques provided below.
a) The Binary Mask Perceptron (BMP) technique that utilizes an adaptor network to generate task specific binary masks to be applied on the meta learner base model (f_{θ}) to dynamically freeze layers depending on task characteristics, and task specific learning rates to determine task specific model initialization parameters capturing distribution specific parameters in inner loop of the training. The task specific model initialization parameters are generalized for the subset of tasks in the outer loop of the training to obtain the single model initialization parameters (θ). The BMP technique is explained in conjunction with FIG. 3 and Algorithm 1.
b) The Multi-modal Meta Supermasks (MMSUP) technique comprising updating generated task specific subnetworks during inner loop of training and updating the single model initialization parameters (θ) during outer loop of the training based on the loss calculated for the task specific and task agnostic parameters of the generated task specific subnetworks. The MMSUP technique is explained in conjunction with FIG. 4 and Algorithm 2.

The BMP technique and the MMSUP technique provide a model initialization that can generalize well on unknown distributions. The MMSUP achieves higher accuracy than the BMP in a cross-domain scenario as it determines parameters which are specific to a task. The BMP does the same but at a higher level of granularity as it considers entire layers, as opposed to specific parameters. However, the MMSUP has a higher training time as compared to the BMP. So, the choice of the BMP or MMSUP is a trade-off between the training time and accuracy expected by the user application. It can be noted that the system can automatically select either of the training technique to train the meta learner base model based on end user inputs provided in accordance with a user application for which the meta learner is used for inferencing. The MMSUP technique is selected for generating the trained meta learner model when the user application provides weightage to accuracy of the trained meta learner model in comparison to a model training time, and the BMP technique is selected when the user application provides weightage to the model training time in comparison to accuracy of the trained metal learner model.

At step 206 of the method 200, the one or more hardware processors 104 utilize the trained meta learner model for inferencing with multi-domain unseen tasks received for prediction.

Thus, unlike multi MAML, rather than training on multiple initializations to improve model performance, the method disclosed herein identifies the effectiveness of a given model parameter for training a task. However, additionally for convergence of a metal learner model, the method also improves performance/accuracy of prediction by transferring positive knowledge between two tasks from different distributions, along with identifying distribution-specific parameters, in a multi-distribution setup using one of the BMP technique and the MMSUP technique.

PRELIMINARIES: As understood, in few-shot learning (FSL), [symbol] samples are available for each of the [symbol] classes, and the goal is to train the meta learner base model (f_{θ}), to converge well on the input dataset [symbol] . Meta learning, especially the GBML algorithm, Model Agnostic Meta Learning (MAML), is often used on few-shot tasks. MAML identifies a good model initialization during training such that the meta learner base model (f_{θ}), is able to rapidly converge on unseen tasks with a few adaptation steps. Given a model f, randomly initialized with parameters θ₀, in conventional training of meta learning model, it is assumed that tasks are sampled from a single distribution p( [symbol] ), such that [symbol] ˜p( [symbol] ). In a k-shot setting, each task consists of [symbol] data points sampled from each of the [symbol] classes present in the task. MAML trains f_{θ} to learn an optimal set of parameters θ′ over tasks [symbol] ∈ Dₜᵣₐᵢₙ such that f_{θ′} converges well on unseen tasks [symbol] ∈ Dₜₑₛₜ, where { [symbol] ∈ Dₜᵣₐᵢₙ, Dₜₑₛₜ} ∈ p( [symbol] ) and Dₜᵣₐᵢₙ∩Dₜₑₛₜ=ϕ. MAML learns an initialization via two optimization loops: 1) Outer loop (learning from all tasks is incorporated to update the model initialization), 2) Inner loop (tasks specific adaptation over few gradient update steps is performed). For a given task [symbol] ᵢ sampled from distribution Dₜᵣₐᵢₙ, with corresponding loss function [symbol] , the task performs fast adaptation using m gradient steps from initial weights θ₀ as shown:

$${θ}_{{𝒯}_{i}}^{m} = {θ}_{{𝒯}_{i}}^{m - 1} - α {∇}_{{θ}_{{𝒯}_{i}}} {ℒ}_{{𝒯}_{i}}^{{𝒟}_{t r a i n}} ( {f}_{{𝒯}_{i}}^{{θ}_{m - 1}} ) \qquad ( 1 )$$

wherein, [symbol] =θ₀. Next, the learning from all the tasks are consolidated to give a generalized performance on tasks sampled from Dₜₑₛₜ. Thus, in the outer loop, one meta initialization is learned that generalizes across all tasks:

θ←θ−β∇_{θ} [symbol] ( [symbol] ) (2)

The disadvantage of MAML is highlighted in equation 2 where knowledge from all tasks gets consolidated. For tasks from multiple distributions, it is unlikely that all tasks can be adapted from a single meta-initialization, which adversely affects the accuracy. Thus, for multi-distribution training, it becomes necessary to identify distribution specific and distribution-agnostic parameters. The BMP and the MMSUP techniques builds upon the conventional MAML to address the technical challenge of deteriorating performance in a multi-distribution setup.

FIG. 3 depicts training of a meta learner base model of the system 100 of FIG. 1 for task generalization to obtain the trained meta learner model using the Binary Mask Perceptron (BMP) technique, in accordance with some embodiments of the present disclosure. The BMP meta-learns distribution-specific layers and distribution-specific learning rate by introducing the adaptor network, interchangeably referred henceforth as binary mask adaptor or adaptor.

MAML-based approaches in the literature such as (Almost No Inner Loop) (ANIL), and (Body Only update in Inner Loop) (BOIL) show significant effectiveness in performance over MAML. ANIL freezes all layers except the head in the inner loop optimization step. However, the BMP technique disclosed by the method herein dynamically freezes layers depending on task characteristics, instead of freezing a fixed set of parameters. Given the meta learner base model f_{θ}, interchangeably referred to as meta learner model, a set of learnable parameters [symbol] are identified and a learning rate [symbol] for input tasks sampled from distribution [symbol] . As depicted in FIG. 3 and Algorithm 1, the meta learner base model f_{θ} is initialized with parameters θ₀, and the adaptor network (g_{ϕ}) with randomly initialized parameters ϕ₀. For a given input task, g_{ϕ} takes as input, (1) features from the current task [symbol] and (2) prior knowledge stored in the form of weights and gradients in f_{θ}, to generate two things as output: (1) the task-specific learning rate and (2) the binary mask to adaptively mask updates for non-trainable layers in f_{θ}. Thus, conventional equation 1 is modified to equation 3 as follows:

$${θ}_{{𝒯}_{i}}^{m , l} = {θ}_{{𝒯}_{i}}^{m - 1 , l} - {α}_{{𝒯}_{i}}^{m - 1} ( B {M}_{l}^{m - 1} ∘ {∇}_{{θ}_{{𝒯}_{i}}} {ℒ}_{{𝒯}_{i}}^{{𝒟}_{t r a i n}} ( {f}_{{𝒯}_{i}}^{{θ}_{m - 1}} ) \qquad ( 3 )$$

wherein, l=1, 2, . . . , L is the l^{th} layer of the model f_{θ}. BMₗ^{m-1} is the binary mask (BM) ∈{0, 1} for the l^{th} layer of the meta learner model at the m−1^{th} gradient update step and [symbol] is the learning rate at the m−1^{th} for the input task [symbol] . (i) binary mask (BM), which is not present in conventional MAML of equation 1, and (ii) learning rate are generated at each gradient update step m in the inner loop using adaptor network g_{ϕ} that is a function of [symbol] , θ and ∇_{θ} [symbol] (f_{θ}) as in equation 4 below:

$$B {M}^{m} , {α}_{{𝒯}_{i}}^{m} = {g}_{ϕ} ( {𝒯}_{i} , {θ}_{{𝒯}_{i}}^{m} , {∇}_{{θ}_{{𝒯}_{i}}} {ℒ}_{{𝒯}_{i}}^{{𝒟}_{t r a i n}} ( {f}_{{𝒯}_{i}}^{{θ}_{m}} ) ) \qquad ( 4 )$$

The BMP technique of the method 200 thus generates the binary mask for every [symbol] in inner loop. The purpose is to learn the weight of a given layer for learning on [symbol] and control the magnitude of the update step. The intuition is that similar tasks will have a larger intersection of shared parameters as compared to dissimilar tasks. Thus, the binary mask is used to efficiently modulate distribution-specific and distribution-agnostic parameters of the meta learner model f_{θ}. Lastly, the parameters ϕ of g_{ϕ} are trained in the outer-loop optimization step as in equation 5 follows:

ϕ←ϕ−β∇_{ϕ} [symbol] ( [symbol] ) (5)

Outer-loop optimization for the meta learner model f_{θ} remains the same equation 2. For masking the binary mask with the gradients of the meta learner model f_{θ}, Straight Through Estimator (STE) from literature, widely used for masking operations is applied. The STE ignores the gradients of the binary mask and backpropagates the gradients unchanged. The implementation details of STE are well known in the art and not explained for brevity., while the model architecture of g_{ϕ} is similar to the original MAML.

Algorithm 1: Binary Mask Perceptron (BMP):

Require: Learning rates η, β, Multi-Task Distributions [symbol] .......... [symbol]
Ensure: Randomly initialize θ, ϕ

| | |
|---|---|
| 1: | while not done do |
| 2: | Sample a batch of tasks [symbol] ∈{ [symbol] .......... [symbol] } |
| 3: | for each [symbol] do |
| 4: | Sample datapoints { [symbol] ₜᵣₐᵢₙ = {x^{(j)}, y^{(j)}} from [symbol] } |
| 5: | Evaluate [symbol] at each gradient step m by evaluating [symbol] w.r.t [symbol] ₜᵣₐᵢₙ |
| 6: | Compute Binary Mask BMₘ and task specific LR am using αₘ using |

| | |
|---|---|
| ${ℊ}_{ϕ} ( {𝒯}_{i} , {θ}_{{𝒯}_{𝒾}}^{m} , {∇}_{{θ}_{{𝒯}_{𝒾}}} {ℒ}_{{𝒯}_{𝒾}}^{{𝒟}_{train}} ( {f}_{{𝒯}_{𝒾}}^{{θ}_{m}} ) )$ | Equation 4 |

| | |
|---|---|
| 7: | Compute updates on task-specific weights using gradient descent: |

${θ}_{{𝒯}_{𝒾}}^{m + 1 , l} = {θ}_{{𝒯}_{𝒾}}^{m , l} - {α}_{{𝒯}_{𝒾}}^{m} ( {BM}_{l}^{m} ∘ {∇}_{{θ}_{{𝒯}_{𝒾}}} {L}_{{𝒯}_{𝒾}}^{{𝒟}_{train}} ( {f}_{{𝒯}_{𝒾}}^{{θ}_{m}} ) )$

| | |
|---|---|
| 8: | Sample datapoints { [symbol] ₜₑₛₜ = {x^{(j)}, y^{(j)}} from [symbol] } for meta-update |
| 9: | end for |
| 10: | Compute [symbol] ( [symbol] ) by evaluating loss-criterion w.r.t [symbol] ₜₑₛₜ. |
| 11: | Update weights: ϕ ← ϕ − β∇ϕ [symbol] [symbol] ( [symbol] ) and θ ← θ − η∇_{ϕ} [symbol] [symbol] ( [symbol] ) |
| 12: | end while |

The steps performed by the Algorithm 1 include:
a) Receiving, by the adapter network, datapoints sampled from each task of the batch of tasks, wherein the adapter network is a function of a current task, task specific model initialization parameters, and a BMP loss associated with the meta learner base model (f_{θ}), and wherein the adapter network has randomly initialized parameters.
b) Extracting, by the adapter network, a plurality of features for each task from the datapoints sampled from each task.
c) Evaluating the BMP loss for each gradient of the meta learner model (f_{θ}) with respect to the datapoints.
d) Processing, (i) the plurality of features of each task and (ii) prior knowledge stored in the form of weights and gradients in meta learner model (f_{θ}), to generate, for each task, during inner training loop of the meta learner model (f_{θ}), (a) a task-specific learning rate and (b) a binary mask to adaptively mask non-trainable layers of the meta learner model (f_{θ}) based on characteristics of each task that modulates distribution specific and distribution-agnostic parameters of the meta learner base model (f_{θ}).
e) Updating the task specific model initialization parameters using the generated binary mask using a gradient descent approach.
f) Receiving the data points from a test data obtained from the dataset.
g) Computing the BMP loss of the test data from the data points of the test dataset.
h) Updating the task specific model initialization parameters and adapter weights based on the computed BMP loss.

FIG. 4 depicts training of the meta learner base model of the system of FIG. 1 for task generalization to obtain a trained meta learner model using a Multi-modal Meta Supermasks (MMSUP) technique, in accordance with some embodiments of the present disclosure. The MMSUP is inspired from Lottery Ticket Hypothesis used by works in literature, thus, identifying distribution-specific subnetworks in the underlying architecture, while sharing knowledge among distribution agnostic parameters. Masking of parameters thus plays an important role in the MMSUP technique disclosed herein.

The MMSUP technique extends BMP to parameter level freezing. The MMSUP technique of the method 200 identifies a subnetwork that is able to learn efficiently on a given task [symbol] . The intuition is that if overlap between the learnable parameters of [symbol] ∈p₀ ( [symbol] ) and [symbol] ∈p₁( [symbol] ) is reduced, it might reduce the deterioration in accuracy. Given [symbol] distributions, MMSUP identifies [symbol] subnets [symbol] ₁, [symbol] ₂, . . . , [symbol] _{N} for each distribution while enabling knowledge sharing between distribution-agnostic parameters of the network. Works in the literature demonstrate that the existence of subnetworks that can be trained to achieve accuracy comparable to that of the original network in the Lottery Ticket Hypothesis. ‘What's hidden in a randomly weighted neural network?’ by Vivek Ramanujan et.al. builds on this by proposing an edge-pop algorithm to find a subnetwork within a randomly initialized overparameterized network.

The MMSUP technique disclosed herein MMSUP backpropagates loss and drops weights, similar to well-known edge-pop algorithm to generate [symbol] subnetworks corresponding to the distributions in the training. As provided Algorithm 2, with reference to FIG. 4, selected is the meta learner base model (f_{θ}), and training distributions p₁( [symbol] ), p₂( [symbol] ), . . . . . . . , p_{N}( [symbol] ), objective is to identify a subset [symbol] ᵢ of parameters of f_{θ} for task [symbol] such that [symbol] ( [symbol] ᵢ)≤ [symbol] (f_{θ}). It can be understood by person having ordinary skill in the domain that the objective of the MMSUP technique is different from conventional approaches identifying subnetworks and the objective is not to identify a subnetwork, rather is to identify a subset of parameters that result in minimum deterioration of accuracy. Thus, rather than maintaining a separate score to learn the ideal subnetwork for an input distribution, the relevant weights of the underlying network f_{θ} are learnt. The sparsity % (k %) present in each of the layers of the underlying architecture using a Multi-Layer Perceptron (MLP) (g_{ϕ}) is learnt.

The MLP is a fully connected network, where each layer consists of 2N hidden units, where N is the number of layers of the base learner network. The ReLU activation function is placed between the MLP layers. The sparsity parameter can be maintained constant; however, it is observed in study that varying sparsity results in better performance. Inner loop update is similar to Equation 1 with some minor changes as in equation 6 below:

[symbol]

= [symbol] −a∇_{θ} [symbol] ( [symbol] ) (6)

wherein, [symbol] is set of top-k % parameters from each of the layers in f_{θ} and [symbol] ᵢ′ are the task agnostic parameters (parameters common across all the distributions). The parameters not belonging to the subset are not updated. Lastly, the outer-loop optimization step is carried out as follows in equation 7 and 8:

$${θ}_{𝒢} = {θ}_{𝒢} - α ( {\sum }_{i = 0}^{𝒯} \frac{{∇}_{θ} {ℒ}_{{𝒢}_{i} - {𝒢}^{′}}^{{𝒟}_{t r a i n}} ( {f}_{{𝒯}_{i}}^{{θ}_{m - 1}} )}{𝒯} ) - α \frac{{∇}_{θ} {ℒ}_{{𝒢}^{′}}^{{𝒟}_{\backslash textittrain}} ( {f}_{{𝒯}_{i}}^{{θ}_{m - 1}} )}{𝒯} \qquad ( 7 )$$

$${g}_{ϕ} ← {g}_{ϕ} - β {∇}_{θ} {\sum }_{{𝒯}_{i}} {ℒ}_{{𝒢}_{i}}^{{𝒟}_{test}} ( {f}_{{𝒢}_{i}}^{{θ}_{m}} ) \qquad ( 8 )$$

wherein, { [symbol] = [symbol] ₁∪ [symbol] ₂∪ . . . ∪ [symbol] }.

Algorithm 2: Multi-modal Meta Supermasks (MMSUP)
Require: Learning rates β, Multi-Task Distributions [symbol] [symbol]
............ [symbol]
Ensure: Randomly initialize θ, ϕ
1: while not done do
2: Sample a batch of tasks [symbol] ϵ { [symbol] ( [symbol] ........... [symbol] }
3: for each [symbol] do
4: Sample datapoints { [symbol] = {x^{(j)}, y^{(j)}} from [symbol] }
5: Compute sparsity % in each layer k ← g_{ϕ}(θ, ∇_{θ})
6: Compute subnetwork [symbol] ᵢ: choose top k% weights in θ₁ for l ϵ
{0, 1, . . . , L}
7: Evaluate [symbol] ( [symbol] ) at each gradient step m by evaluating [symbol]
w.r.t [symbol]
8: Compute updates only on subnetwork [symbol] ᵢ using gradient descent: [symbol]
= [symbol] −α (BMₗ^{m} ○ ∇_{θ} [symbol] ( [symbol] ))
9: Weights, not present, in the subnetwork: [symbol] = [symbol]
10: Sample datapoints { [symbol] = {x^{(j)}, y^{(j)}} from [symbol] } for meta-update
11: end for
12: Compute [symbol] ( [symbol] ) by evaluating loss-criterion w.r.t [symbol] •
13: Update weights: θ_{G} ← θ_{G} − α [symbol] (∇_{θ} [symbol] ( [symbol] ) −
∇_{θ} [symbol] ₍ [symbol] ₎₎
14: Update MLP weights g_{ϕ} ← g_{ϕ} − β∇_{θ} [symbol] [symbol] ( [symbol] )
15: end while

The steps performed by the Algorithm 2 include:
a) Receiving datapoints sampled from each task of the batch of tasks.
b) Computing a sparsity (k %) of each layer of the meta learner base model (f_{θ}), using the MLP.
c) Generating the subnetwork with the top K weights for each task in the training using modified or improved edge pop-algorithm.
d) Computing a MMSUP loss for each gradients for the generated subnetwork.
e) Determining weights which are not present in the subnetwork associated with each task.
f) Updating the subnetwork based on the computed MMSUP loss function using a gradient descent approach during inner loop of the training, wherein the weights which are not present in the subnetwork remain unchanged.
g) Computing the MMSUP loss of a test data set from the datapoints of the test dataset.
h) Updating the task specific model initialization parameters and a MLP weight based on the computed MMSUP loss function.

### Experiments

Both the BMP technique and the MMSUP technique is evaluated in the image classification domain, using quasi-benchmark datasets from the field of meta-learning. The approaches disclosed herein are compared with the baselines as MAML and Multi-MAML. MAML represents the family of model agnostic meta learners and is known to generalize well on tasks from known distributions and hence forms the baseline for the experiments for training accuracy of the meta learner model. Multi-MAML comprises of M (number of different modalities) MAML models, and the approach disclosed is compared against the large training times incurred in a Multi-MAML scenario. The BMP and the MMSUP techniques are both training a single base model, unlike Multi-MAML and are thus compute optimal. Unlike MAML, both approaches have been designed to work on diverse distributions. The efficacy of is illustrated on 5 image datasets, namely, CUBirds, Aircraft, VGG Flowers and Fungi. All experiments are conducted on dedicated MIG A100 GPU setup, with 30 GB RAM, 8vCPUS and 10 GB GPU memory. Each experiment has been repeated 3 times with different seeds to ensure sufficient randomness.

Multi-distribution performance of the BMP and the MMSUP: Table 1 depicts training a single model in a multi-distribution scenario, i.e., the model is trained on 2, 3 or 4 datasets.

TABLE 1
5ways, 1 shot - Same Distribution

| | | Meta-learning Architectures | | | | | | | |
|---|---|---|---|---|---|---|---|---|---|
| | | MAML | | Multi-MAML | | BMP | | MMSUP | |
| Training | Testing | Accura- | | Accura- | | Accura- | | Accura- | |
| Distrib. | Distrib. | cy | Time | cy | Time | cy | Time | cy | Time |
| CUB200+ | CUB200 | 0.506 ± | 6.58 | 0.533 ± | 11.57 | 0.563 ± | 6.63 | 0.524 ± | 7.17 |
| | | 0.008 | | 0.011 | | 0.006 | | 0.028 | |
| VGG102 | VGG102 | 0.703 ± | | 0.719 ± | | 0.751 ± | | 0.723 ± | |
| | | 0.009 | | 0.011 | | 0.005 | | 0.022 | |
| CUB200 | CUB200 | 0.487 ± | 6.33 | 0.533 ± | 13.58 | 0.522 ± | 7.46 | 0.525 ± | 7.79 |
| | | 0.016 | | 0.011 | | 0.028 | | 0.022 | |
| +Fungi | Fungi | 0.392 ± | | 0.424 ± | | 0.421 ± | | 0.425 ± | |
| | | 0.014 | | 0.006 | | 0.034 | | 0.005 | |
| CUB200 | CUB200 | 0.483 ± | 7.02 | 0.533 ± | 19.06 | 0.543 ± | 6.52 | 0.517 ± | 7.35 |
| | | 0.015 | | 0.011 | | 0.002 | | 0.027 | |
| +VGG102 | VGG102 | 0.691 ± | | 0.719 ± | | 0.733 ± | | 0.691 ± | |
| | | 0.011 | | 0.01 | | 0.015 | | 0.017 | |
| +Fungi | Fungi | 0.405 ± | | 0.424 ± | | 0.441 ± | | 0.403 ± | |
| | | 0.006 | | 0.006 | | 0.004 | | 0.003 | |
| CUB200 | CUB200 | 0.479 ± | 5.59 | 0.533 ± | 28.49 | 0.517 ± | 7.72 | 0.487 ± | 8.23 |
| | | 0.010 | | 0.011 | | 0.011 | | 0.018 | |
| +VGG102 | VGG102 | 0.677 ± | | 0.719 ± | | 0.649 ± | | 0.689 ± | |
| | | 0.011 | | 0.011 | | 0.005 | | 0.019 | |
| +Fungi | Fungi | 0.398 ± | | 0.424 ± | | 0.423 ± | | 0.380 ± | |
| | | 0.004 | | 0.006 | | 0.013 | | 0.006 | |
| +Aircraft | Aircraft | 0.283 ± | | 0.400 ± | | 0.402 ± | | 0.349 ± | |
| | | 0.004 | | 0.010 | | 0.025 | | 0.012 | |

The trained meta learner model was tested on unseen tasks from known distributions. BMP and MMSUP outperform base-MAML in terms of accuracy or achieve a comparable accuracy as both the approaches focus on identifying layers or parameters which are specific to the distribution when training. The BMP and MMSUP achieve a lower training time compared to Multi-MAML as Multi-MAML trains a separate model for each modality. Table 2 depicts the cross-domain results, where model is trained on multiple distributions and tested on tasks from unseen distributions.

TABLE 2
5ways, 1 shot - Cross Domain

| | | Meta-learning Architectures | | | | | | | |
|---|---|---|---|---|---|---|---|---|---|
| | | | | | | | | MMSUP | |
| | | | | Multi- | | | | Accuracy | |
| | | MAML | | MAML | | BMP | | Time | |
| Training | Testing | Accur- | | Accur- | | Accur- | | Accur- | |
| Distrib. | Distrib. | acy | Time | acy | Time | acy | Time | acy | Time |
| CUB200 | Fungi | 0.410 | 6.58 | 0.361 | 11.57 | 0.411 | 6.62 | 0.388 | 7.17 |
| +VGG102 | Aircraft | 0.269 | | 0.277 | | 0.307 | | 0.291 | |
| CUB200 | VGG102 | 0.603 | 6.33 | 0.638 | 13.58 | 0.684 | 7.46 | 0.611 | 7.8 |
| +Fungi | Aircraft | 0.268 | | 0.277 | | 0.294 | | 0.306 | |

Both BMP and MMSUP achieve a better accuracy than MAML as MAML is known to generalize well on tasks from a similar distribution. The training time is as depicted in Table 1.

Ablation Studies: The training time, and the accuracy on 5-way 1-shot training of two distributions (VGG102 and CUB200 datasets) instances on 4-CONN backbone is recorded. All the results in the subsequent subsections have been tested on VGG102 dataset.

Ablation study on adaptation steps: The effectiveness of BMP and MMSUP techniques is first analyzed during rapid learning by varying the number of adaptation steps in the inner loop. As the number of adaptation (gradient) steps increases, the meta learner model learns more task-specific parameters. The accuracy and training time for both BMP and MMSUP is measured when trained on different number of adaptation steps as shown in Table 5.

As observed from Table 5, regardless of the number of adaptation steps, both BMP and MMSUP outperform the accuracy of MAML algorithm trained on 5 adaptation steps. Furthermore, performance of BMP improves as adaptation steps decrease. As MMSUP does not show a significant change in accuracy, we conclude that increasing the number of adaptation steps does not affect the accuracy of the algorithms 1 and 2 significantly. This leads us to hypothesize that BMP and MMSUP already learned a good prior. During test time, it results in rapid convergence in just one adaptation step on the input task eventually making additional adaptation steps redundant.

Ablation study on varying sparsity: To get an understanding of how sparsity affects the performance of MMSUP, the sparsity value is kept constant across all the layers (including head layer) of the 4-CONN backbone. As an example, observations on VGG102 and CUB200 datasets in Table 3 are plotted.

TABLE 3
Varying Sparsity

| | Sparsity Value | | | | | | | | |
|---|---|---|---|---|---|---|---|---|---|
| | 0.1 | 0.2 | 0.3 | 0.4 | 0.5 | 0.6 | 0.7 | 0.8 | 0.9 |
| VGG102 | 0.669 | 0.676 | 0.676 | 0.681 | 0.671 | 0.681 | 0.665 | 0.652 | 0.653 |
| CUB200 | 0.509 | 0.502 | 0.52 | 0.515 | 0.509 | 0.512 | 0.501 | 0.499 | 0.475 |

A similar pattern is observed for rest of the distributions. It is observed that as sparsity increases, the accuracy and training time both decrease. However, the accuracy performance for both VGG102 and CUB200 is sub-optimal as compared to MAML trained on zero sparsity. This leads us to conclude that keeping a fixed sparsity value does not result in an optimal performance and recognizing a pattern across layers becomes important.

Ablation study on varying sparsity with depth: Building up on the previous ablation study, the sparsity percentage is varied in each layer and observations are recorded in Table 4.

TABLE 4
Varying Sparsity with depth of network

| | Sparsity Depth | | | | | | | |
|---|---|---|---|---|---|---|---|---|
| Datasets | S1 | S2 | S3 | S4 | S5 | S6 | S7 | S8 |
| VGG102 | 0.671 | 0.672 | 0.678 | 0.679 | 0.706 | 0.666 | 0.664 | 0.671 |
| CUB200 | 0.491 | 0.496 | 0.488 | 0.494 | 0.515 | 0.503 | 0.503 | 0.504 |

TABLE 5
Adaptation Steps for BMP and MMSUP

| | # Adaptation Steps | | | | |
|---|---|---|---|---|---|
| Algorithm | 1 | 2 | 3 | 4 | 5 |
| BMP | 0.774 | 0.764 | 0.755 | 0.746 | 0.739 |
| MMSUP | 0.734 | 0.722 | 0.703 | 0.689 | 0.723 |

It is observed that as the sparsity decreases with depth, the accuracy increases. This phenomenon is recorded on VGG102 and CUB200 data sets, but the same trend is observed on the other two distributions too. It can be concluded from this study that MMSUP learns on the initial layers early in the training. This conclusion is consistent with the findings of works in literature that manually freeze layers of the backbone in the inner loop update. Thus, automating the process of identifying sparsity in each layer helps MMSUP outperform hand designed algorithms such as ANIL and BOIL.

The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means, and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method for model generalization in multiple distributions during meta learning, the method comprising:
sampling, by one or more hardware processors, a dataset having task distribution across a plurality of classes to generate a batch of tasks comprising tasks across the plurality of classes;
training, by the one or more hardware processors, a meta learner base model (f_{θ}), with each task from among the batch of tasks for task generalization to obtain a trained meta learner model having single model initialization parameters (θ) providing model generalization for the batch of tasks, wherein training is based on one of:
(i) a Binary Mask Perceptron (BMP) technique that utilizes an adaptor network to generate task specific binary masks, wherein the task specific binary masks are applied on the meta learner base model (f_{θ}) to dynamically freeze layers depending on task characteristics, and task specific learning rates to determine task specific model initialization parameters capturing distribution specific parameters in inner loop of the training, wherein the task specific model initialization parameters are generalized for the subset of tasks in the outer loop of the training to obtain the single model initialization parameters (θ); and
(ii) a Multi-modal Meta Supermasks (MMSUP) comprising updating generated task specific subnetworks during inner loop of training and updating the single model initialization parameters (θ) during outer loop of the training based on the loss calculated for the task specific and task agnostic parameters of the generated task specific subnetworks.; and
utilizing, by the one or more hardware processors, the trained meta learner model for inferencing with tasks from multiple distributions received for prediction for a user application.

2. The method of claim 1, wherein time to obtain the single model initialization parameters (θ) using the BMP technique and the MMSUP technique is less than gold standard multi-Model-Agnostic Meta-Learners (multi-MAML) with accuracy of the trained meta learner model at least equal to baseline MAML.

3. The method of claim 1, wherein the MMSUP technique is selected for generating the trained meta learner when the user application involves cross-domain scenario, wherein the MMSUP technique determines parameters which are specific to a task and achieves higher accuracy than the BMP technique.

4. The method of claim 1, wherein the BMP technique comprises:
receiving, by the adapter network, datapoints sampled from each task of the batch of tasks, wherein the adapter network is a function of a current task, task specific model initialization parameters, and a BMP loss associated with the meta learner base model (f_{θ}), and wherein the adapter network has randomly initialized parameters;
extracting, by the adapter network, a plurality of features for each task from the datapoints sampled from each task;
evaluating the BMP loss for each gradient of the meta learner model (f_{θ}) with respect to the datapoints;
processing, (i) the plurality of features of each task and (ii) prior knowledge stored in the form of weights and gradients in meta learner model (f_{θ}), to generate, for each task, during inner training loop of the meta learner model (f_{θ}), (a) a task-specific learning rate and (b) a binary mask to adaptively mask non-trainable layers of the meta learner model (f_{θ}) based on characteristics of each task that modulates distribution specific and distribution-agnostic parameters of the meta learner base model (f_{θ});
updating the task specific model initialization parameters using the generated binary mask using a gradient descent approach;
receiving the data points from a test data obtained from the dataset;
computing the BMP loss of the test data from the data points of the test dataset; and
updating the task specific model initialization parameters and adapter weights based on the computed BMP loss.

5. The method of claim 1, wherein the MMSUP technique comprises:
receiving datapoints sampled from each task of the batch of tasks;
computing a sparsity (k %) of each layer of the meta learner base model (f_{θ}), using a Multi-Layer Perceptron (MLP);
generating a subnetwork with top-K weights for each task in the batch of tasks;
computing a MMSUP loss for each gradients for the generated subnetwork;
determining weights which are not present in the subnetwork associated with each task;
updating the subnetwork based on the computed MMSUP loss function using a gradient descent approach during inner loop of the training, wherein the weights which are not present in the subnetwork remain unchanged;
computing the MMSUP loss of a test data set from the datapoints of the test dataset; and
updating the task specific model initialization parameters and a MLP weight based on the computed MMSUP loss function.

6. A system for model generalization in multiple distributions during meta learning, the system comprising:
a memory storing instructions;
one or more Input/Output (I/O) interfaces; and
one or more hardware processors coupled to the memory via the one or more I/O interfaces, wherein the one or more hardware processors are configured by the instructions to:
sample a dataset having task distribution across a plurality of classes to generate a batch of tasks comprising tasks across the plurality of classes;
train a meta learner base model (f_{θ}), with each task from among the batch of tasks for task generalization to obtain a trained meta learner model having single model initialization parameters (θ) providing model generalization for the batch of tasks, wherein training is based on one of:
(i) a Binary Mask Perceptron (BMP) technique that utilizes an adaptor network to generate task specific binary masks, wherein the task specific binary masks are applied on the meta learner base model (f_{θ}) to dynamically freeze layers depending on task characteristics, and task specific learning rates to determine task specific model initialization parameters capturing distribution specific parameters in inner loop of the training, wherein the task specific model initialization parameters are generalized for the subset of tasks in the outer loop of the training to obtain the single model initialization parameters (θ); and
(ii) a Multi-modal Meta Supermasks (MMSUP) technique comprising updating generated task specific subnetworks during inner loop of training, and updating the single model initialization parameters (θ) during outer loop of the training based on the loss calculated for the task specific and task agnostic parameters of the generated task specific subnetworks; and
utilize the trained meta learner model for inferencing with tasks from multiple distributions received for prediction for a user application.

7. The system of claim 6, wherein time to obtain the single model initialization parameters (θ) using the BMP technique and the MMSUP technique is less than gold standard multi-Model-Agnostic Meta-Learners (multi-MAML) with accuracy of the trained meta learner model at least equal to baseline MAML.

8. The system of claim 6, wherein the MMSUP technique is selected for generating the trained meta learner when the user application involves cross-domain scenario, wherein the MMSUP technique determines parameters which are specific to a task and achieves higher accuracy than the BMP technique.

9. The system of claim 6, wherein the BMP technique comprises:
receiving, by the adapter network, datapoints sampled from each task of the batch of tasks, wherein the adapter network is a function of a current task, task specific model initialization parameters, and a BMP loss associated with the meta learner base model (f_{θ}), and wherein the adapter network has randomly initialized parameters;
extracting, by the adapter network, a plurality of features for each task from the datapoints sampled from each task;
evaluating the BMP loss for each gradient of the meta learner model (f_{θ}) with respect to the datapoints;
processing, (i) the plurality of features of each task and (ii) prior knowledge stored in the form of weights and gradients in meta learner model (f_{θ}), to generate, for each task, during inner training loop of the meta learner model (f_{θ}), (a) a task-specific learning rate and (b) a binary mask to adaptively mask non-trainable layers of the meta learner model (f_{θ}) based on characteristics of each task that modulates distribution specific and distribution-agnostic parameters of the meta learner base model (f_{θ});
updating the task specific model initialization parameters using the generated binary mask using a gradient descent approach;
receiving the data points from a test data obtained from the dataset;
computing the BMP loss of the test data from the data points of the test dataset; and
updating the task specific model initialization parameters and adapter weights based on the computed BMP loss.

10. The system of claim 6, wherein the MMSUP technique comprises:
receiving datapoints sampled from each task of the batch of tasks;
computing a sparsity (k %) of each layer of the meta learner base model (f_{θ}), using a Multi-Layer Perceptron (MLP);
generating a subnetwork with top-K weights for each task in the batch of tasks;
computing a MMSUP loss for each gradients for the generated subnetwork;
determining weights which are not present in the subnetwork associated with each task;
updating the subnetwork based on the computed MMSUP loss function using a gradient descent approach during inner loop of the training, wherein the weights which are not present in the subnetwork remain unchanged;
computing the MMSUP loss of a test data set from the datapoints of the test dataset; and
updating the task specific model initialization parameters and a MLP weight based on the computed MMSUP loss function.

11. One or more non-transitory machine-readable information storage mediums comprising one or more instructions which when executed by one or more hardware processors cause:
sampling a dataset having task distribution across a plurality of classes to generate a batch of tasks comprising tasks across the plurality of classes;
training a meta learner base model (f_{θ}), with each task from among the batch of tasks for task generalization to obtain a trained meta learner model having single model initialization parameters (θ) providing model generalization for the batch of tasks, wherein training is based on one of:
(i) a Binary Mask Perceptron (BMP) technique that utilizes an adaptor network to generate task specific binary masks, wherein the task specific binary masks are applied on the meta learner base model (f_{θ}) to dynamically freeze layers depending on task characteristics, and task specific learning rates to determine task specific model initialization parameters capturing distribution specific parameters in inner loop of the training, wherein the task specific model initialization parameters are generalized for the subset of tasks in the outer loop of the training to obtain the single model initialization parameters (θ); and
(ii) a Multi-modal Meta Supermasks (MMSUP) comprising updating generated task specific subnetworks during inner loop of training and updating the single model initialization parameters (θ) during outer loop of the training based on the loss calculated for the task specific and task agnostic parameters of the generated task specific subnetworks.; and
utilizing, the trained meta learner model for inferencing with tasks from multiple distributions received for prediction for a user application.

12. The one or more non-transitory machine readable information storage mediums of claim 11, wherein time to obtain the single model initialization parameters (θ) using the BMP technique and the MMSUP technique is less than gold standard multi-Model-Agnostic Meta-Learners (multi-MAML) with accuracy of the trained meta learner model at least equal to baseline MAML.

13. The one or more non-transitory machine readable information storage mediums of claim 11, wherein the MMSUP technique is selected for generating the trained meta learner when the user application involves cross-domain scenario, wherein the MMSUP technique determines parameters which are specific to a task and achieves higher accuracy than the BMP technique.

14. The one or more non-transitory machine readable information storage mediums of claim 11, wherein the BMP technique comprises:
receiving, by the adapter network, datapoints sampled from each task of the batch of tasks, wherein the adapter network is a function of a current task, task specific model initialization parameters, and a BMP loss associated with the meta learner base model (f_{θ}), and wherein the adapter network has randomly initialized parameters;
extracting, by the adapter network, a plurality of features for each task from the datapoints sampled from each task;
evaluating the BMP loss for each gradient of the meta learner model (f_{θ}) with respect to the datapoints;
processing, (i) the plurality of features of each task and (ii) prior knowledge stored in the form of weights and gradients in meta learner model (f_{θ}), to generate, for each task, during inner training loop of the meta learner model (f_{θ}), (a) a task-specific learning rate and (b) a binary mask to adaptively mask non-trainable layers of the meta learner model (f_{θ}) based on characteristics of each task that modulates distribution specific and distribution-agnostic parameters of the meta learner base model (f_{θ});
updating the task specific model initialization parameters using the generated binary mask using a gradient descent approach;
receiving the data points from a test data obtained from the dataset;
computing the BMP loss of the test data from the data points of the test dataset; and
updating the task specific model initialization parameters and adapter weights based on the computed BMP loss.

15. The one or more non-transitory machine readable information storage mediums of claim 11, wherein the MMSUP technique comprises:
receiving datapoints sampled from each task of the batch of tasks;
computing a sparsity (k %) of each layer of the meta learner base model (f_{θ}), using a Multi-Layer Perceptron (MLP);
generating a subnetwork with top-K weights for each task in the batch of tasks;
computing a MMSUP loss for each gradients for the generated subnetwork;
determining weights which are not present in the subnetwork associated with each task;
updating the subnetwork based on the computed MMSUP loss function using a gradient descent approach during inner loop of the training, wherein the weights which are not present in the subnetwork remain unchanged;
computing the MMSUP loss of a test data set from the datapoints of the test dataset; and
updating the task specific model initialization parameters and a MLP weight based on the computed MMSUP loss function.
